(19) United States
(12) Patent Application Publication
(10) Pub. No.: US 2025/0329008 A1
(43) Pub. Date: Oct. 23, 2025

(54) METHODS AND SYSTEM FOR INDUSTRIAL DEFECT IDENTIFICATION

(71) Applicant: RTX Corporation, Farmington, CT (US)

(72) Inventor: Yang YU, Farmington, CT (US)

(73) Assignee: RTX Corporation, Farmington, CT (US)

(21) Appl. No.: 18/641,576

(22) Filed: Apr. 22, 2024

(51) Int. Cl. G06T 7/00; G06T 7/11

(52) U.S. Cl. CPC G06T 7/0008; G06T 7/11

(57) ABSTRACT

An inspection system includes a model architecture for industrial defect identification. The model architecture includes a text encoder model that receives a text object having free-form text and generates a text embedding. A visual encoder model receives a region of interest of an image and generates a region embedding. A cross-modality fusion layer acts between the text encoder model and the visual encoder model to fuse outputs of nodes within the models to be used as inputs to nodes in a subsequent layer. A cross-modality decoder model aligns the text embedding and the region embedding to generate a bounding box for the region if it is similar to the text object. A positional encoder generates a positional embedding based on the bounding box. A mask decoder model generates a segmentation mask based on the positional embedding within an output to highlight the region defined by the text object.

### FIELD OF THE INVENTION

The present invention relates to methods and a system using models to inspect images of components and receive text descriptions of the defects to be detected in the images to find objects in the images that match the descriptions.

### DESCRIPTION OF THE RELATED ART

Components, or parts, sometimes contain defects that need to be detected. Detection of the defects is usually performed by human inspection. Human inspections, however, are labor-intensive and time consuming. Further, the process is prone to errors. Artificial intelligence (AI) systems may automate the inspection process using computer scans or images. AI systems, however, require training datasets for possible defects, which may not be readily available. Some defects may not be appreciated at the present time so that the AI models can be trained on them.

Thus, a need for an AI inspection system not requiring defect-specific training in order to deploy for industrial defect identification.

### SUMMARY OF THE INVENTION

A method is disclosed. The method includes generating a text embedding using a text encoder model for a text object of free-form text. The method also includes generating a region embedding within an image using a visual encoder model. The region embedding defines a region of interest within the image. The method also includes fusing output of a layer within the text encoder model with output of a layer within the visual encoder model using a cross-modality fusion layer. The method also includes using the fused outputs of the layers of the text encoder model and the visual encoder model as input to a subsequent layer of the text encoder model and the visual encoder model. The method also includes aligning the text embedding with the region embedding to generate a bounding box for at least one instance of the text object using a cross-modality decoder model if the at least one instance of the text object is present in the image. The method also includes generating a positional embedding using a positional encoder based on coordinates of the bounding box. The positional embedding indicates a location of the at least one instance of the text object within the image.

A method of industrial defect identification is disclosed. The method includes receiving an image of a component. The method also includes receiving a text object of free-form text describing a defect of the component to be identified within the image. The method also includes generating a text embedding using a text encoder model based on the text object. The method also includes generating a region embedding for the image using a visual encoder model. The region embedding defines a region of interest within the image. The outputs of at least one layer within the visual encoder model are fused with outputs of at least one layer within the text encoder model so that the fused outputs are input into a subsequent layer within the text encoder model and the visual encoder model. The method also includes predicting how similar the text embedding and the region embedding are to each other using a cross-modality decoder model. The method also includes determining a positional embedding using a positional encoder based on the prediction. The positional embedding indicates a location of an instance of the text object within the image. The method also includes generating a segmentation mask for the instance of the text object based on the positional embedding.

A system for industrial defect identification is disclosed. The system includes a text encoder model configured to generate a text embedding for a text object of free-form text. The text object relates to a feature within an image of a component. The system also includes a visual encoder model configured to generate a region embedding within the image of the component. The region embedding defines a region of interest within the image. The system also includes a cross-modality fusion layer configured to fuse output of a layer within the text encoder model with output of a layer within the visual encoder model. The fused outputs of the layers of the text encoder model and the visual encoder model are used as inputs to a subsequent layer of the text encoder model and the visual encoder model. The system also includes a cross-modality decoder model configured to align the text embedding within the region embedding to generate a bounding box for at least one instance of the text object if the at least one instance of the text object is present in the image. The system also includes a positional encoder configured to generate a positional embedding based on coordinates of the bounding box. The positional embedding indicates a location of the text object within the image.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, numerous variations are possible. For instance, structural elements and process steps may be rearranged, combined, distributed, eliminated, or otherwise changed, while remaining with the scope of the disclosed embodiments.

### BRIEF DESCRIPTION OF THE DRAWINGS

Implementations of the inventive concepts disclosed herein may be better understood when consideration is given to the following detailed description thereof. Such description refers to the included drawings, which are not necessarily to scale, and which some features may be exaggerated and some features may be omitted or may be represented schematically in the interest of clarity. Like reference numerals in the drawings may represent and refer to the same or similar element, feature, or function. In the drawings:

FIG. 1 illustrates a block diagram of an inspection system for detecting industrial defects of a component according to the disclosed embodiments.

FIG. 2 illustrates a block diagram of a cross-modality fusion layer for use with a text encoder model and a visual encoder model according to the disclosed embodiments.

FIG. 3 illustrates an example output having a segmentation mask using a model architecture according to the disclosed embodiments.

FIG. 4 illustrates a flowchart for industrial defect identification using the inspection system according to the disclosed embodiments.

### DETAILED DESCRIPTION OF THE PREFERRED EMBODIMENTS

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of the embodiments of the inventive concepts, numerous specific details are set forth in order to provide a more thorough understanding of the inventive concepts. It will be apparent to one skilled in the art, however, having the benefit of the instant disclosure that the inventive concepts disclosed herein may be practiced without these specific details.

As used herein, a letter following a reference numeral is intended to reference an embodiment of the feature or element that may be similar, but not necessarily identical, to a previously described element or feature bearing the same reference numeral, such as 1, 1a, or 1b. Such shorthand notations are used for purposes of convenience only, and should not be construed to limit the inventive concepts disclosed herein in any way unless expressly stated to the contrary.

Moreover, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes plural unless it is obvious that it is meant otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

As used herein, any reference to “one embodiment,” “alternative embodiments,” or “some embodiments” means that particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination or sub-combination of two or more such features, along with any other features that may not necessarily be expressly described or inherently present in the instant disclosure.

The inventive concepts may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

Inventive concepts may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed below.

The disclosed embodiments provide a multi-modal inspection system for zero-shot defect detection. The inspection system leverages an encoder-decoder architecture built on foundational vision and language models. A foundational model may be one that does not require training datasets to process data. Images of the component, or part, to be inspected is provided to the inspection system. Text descriptions of the defects, or features, to be detected in the images also are provided. The inspection system interprets the visual meaning of the natural language of the text descriptions and tries to find objects in the images that are similar to the description. If the defect, or feature, is found, then the inspection system generates a segmentation mask for each instance of the defect, or feature. The segmentation mask may be a polygon covering the entire area of the defect, or feature, and may be used to locate the defect instances and compute their sizes.

The disclosed inspection system is lightweight and provides zero-shot capability. The disclosed inspection system does not require any training to deploy and may detect arbitrary objects as long as they can be described using natural language. This feature is in contrast to traditional computer vision systems that can only detect object classes labeled in the training dataset. The disclosed inspection system does not require a large training dataset of defects and is not limited to only well-known defects or features in the images. The disclosed inspection system may detect defects or features that may not be available for training datasets due to scarcity within training images.

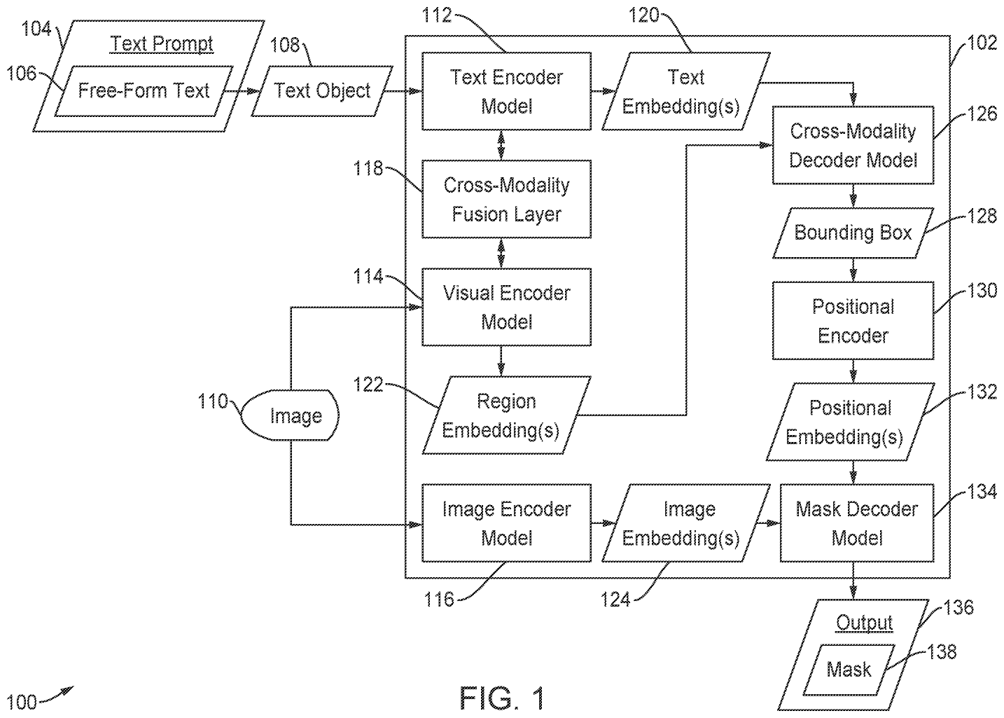

FIG. 1 depicts a block diagram of an inspection system 100 for detecting industrial defects of a component according to the disclosed embodiments. Although the term “defect” may be used in disclosing the features of inspection system 100, it may be appreciated that a feature also may be identified for the component. Further, image 110 may not be of a component, but may include a location or area having items, such as vehicles, planes, or other features able to be described using natural language. Component also may relate to a part or sub-component of a physical device or system.

Model architecture 102 receives text object 108 of free-form text 106 and image 110 of a component, such as a fan blade of an integrally bladed rotor (IBR). The component may be a part submitted for analysis by inspection system 100. Using these inputs, model architecture 102 provides output 136 that includes image 110 of the component with a positional embedding 132 showing the feature described by text object 108. For example, output 136 may include an image of a part that highlights a crack or defect within the part. Model architecture 102 performs these operations using AI models without the need to train the models.

Text prompt 104 provides a user interface to receive free-form text 106. Once entered into text prompt 104, free-form text 106 is placed into text object 108. Text prompt 104 and free-form text 106 allows a user to enter natural language describing a feature of interest within or on a component subject to inspection. This feature allows a query to be made of inspection system 100 that resembles how one thinks or speaks. The user does not have to use suggested words or codes to use inspection system 100. For example, free-form text 106 may read “narrow crack on metal surface.” Text object 108 may include the words of free-form text 106.

Text object 106 is input to text encoder model 112. Text encoder model 112 is a neural network model that converts text object 108 into one or more text embeddings 120. Text encoder model 112 is a foundational model in that is does not have to be trained to be implemented within model architecture 102. Text encoder model 112 uses natural language processing on text object 108 to generate one or more text embeddings 120. Text encoder model 112 may turn words and larger units of text into embeddings. Text embeddings 120 may be vectors suitable for a computer model to understand. These vector representations are designed to capture the semantic meaning and context of the words of text object 108. Text embeddings 120 may have a number of values, or dimensions, corresponding to free-form text 106. Text encoder model 112 generates the dimension using the technique developed for the model.

Image 110 is input to visual encoder model 114. Visual encoder model 114 also is a neural network model. In some embodiments, visual encoder model 114 also is a foundational model. Visual encoder model 114 may take image 110 to determine regions of interest within the image to generate region embeddings 122. Region embeddings 122 also may be vectors for the regions of interest within image 110. Visual encoder model 114 may be a sequence model to convert portions of image 110 having regions of interest into data or numbers for regions embeddings, or vectors, 122.

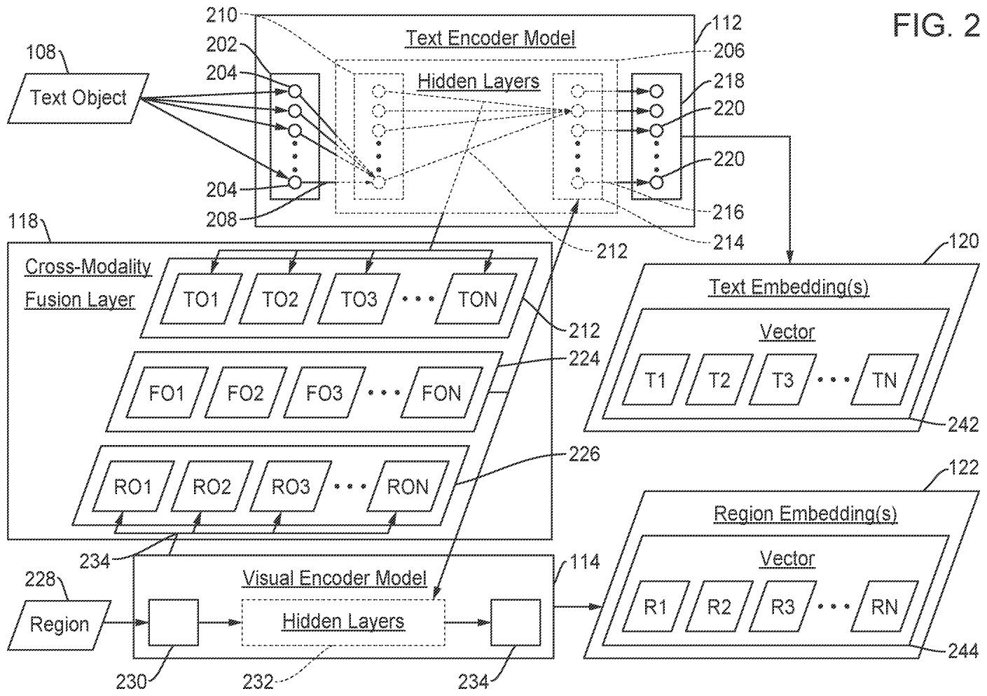

In additional to text encoder model 112 and visual encoder model 114, model architecture 102 also includes a cross-modality fusion layer 118. Cross-modality fusion layer 118 fuses intermediate representations between the models. Cross-modality fusion layer 118 is disclosed in greater detail below in FIG. 2. This fusion of outputs between layers in the models results in text embeddings 120 and region embeddings 122 having some features from text object 108 and image 110 in the vectors output from the models.

Cross-modality decoder model 126 receives text embeddings 120 and region embeddings 122. Cross-modality decoder model 126 also may be a foundational model that does not require any specialized training for specific defects, including those not readily apparent when inspection system 100 is configured. As with the use of the other foundational models disclosed above, the pre-training phases uses a large amount of data to enable the models to be able to generalize. Thus, foundational models may be utilized “out of the box” without additional task-specific training.

Cross-modal learning may refer to learning that involves information obtained from more than one modality that are not necessarily aligned. In this instance, the modalities would be text and image. Cross-modality decoder model 126 analyzes the data points within text embeddings 120 and region embeddings 122 to determine if they are “close.” Distance may be determined between a vector in a text embedding 120 and a vector in region embedding 122 within two-dimensional (2D) or three-dimensional (3D) spaces.

If the vectors within text embedding 120 and region embedding 122 line up, or are close enough in the joint vector space, then cross-modality decoder model 126 predicts that the data within the vectors are similar. In other words, the distance is measured between the vectors in space. If the distance is within a specified range, or less than a specified threshold, then text embedding 120 and region embedding 122 may be predicted to specify the same item. For example, if text embedding 120 includes data specifying a narrow crack and region embedding 122 includes data with image 110 showing a crack, then cross-modality decoder model 126 will predict that the vectors for the embeddings are similar.

Examples of a specified threshold include the use of a confidence score. The confidence score has a value, such as a number between 0 and 1. Thus, if the confidence score of a bounding box is larger than the threshold, the model will produce the bounding box. The specified threshold may be set manually to reflect how confident one wants the model predictions to be. For example, certain critical components or parts may want to identify potential defects even with a lower confidence score due to the importance of identifying the defects.

Further using the examples provided above, text embeddings 120 may include a vector having data points for a narrow crack on metal surface. The data points include values determined by text encoder model 112 to represent the text in a space for “narrow crack on metal surface.” In parallel, visual encoder model 114 generates a vector having data points for a region showing a narrow crack on a metal surface. The data points correspond to the visual features of the narrow crack on the metal surface within the region in image 110. Cross-modality decoder model 126 analyzes these data points within the vectors of the embeddings to determine how similar they are.

In some embodiments, the embeddings are considered similar if they are close enough according to a specified criterion. Cross-modality decoder model 126 may take the text and region embeddings to perform cross-modality attention, which may serve as an additional fusion operation. Then, it computes the confidence score based on the distance between the text and region embedding vectors. If the confidence score between the region and text embeddings exceeds the threshold, then the bounding box is generated.

If cross-modality decoder model 126 determines text embedding 120 and region embedding 122 are close, then model architecture 102 generates a bounding box 128 for the region corresponding to region embedding 122. Cross-modality decoder model 126 also determines a confidence score for bounding box 128. The confidence score may be computed based on the distance between the text and region embedding vectors. The distance may be passed into another function call sigmoid function that will produce a score between 0 and 1. The confidence score, as disclosed above, may be between 0 and 1 that the region within bounding box 128 matches text object 108. The confidence score is based on the distance between the data points for text embedding 120 and region embedding 122, as disclosed above.

Bounding box 128 is represented by coordinates generated by cross-modality decoder model 126. Bounding box 128 may be represented for four points on image 110. Each point may have a coordinate (x,y) that indicates its location in image 110. In some embodiments, eight (8) coordinates are provided for bounding box 128. The eight coordinates should contain the data points for text embedding 120 and region embedding 122 in space that defines the object of interest in image 110. Bounding box 128 encloses the area within space defined by the coordinates.

Bounding box 128 is provided to positional encoder 130. Positional encoder 130 also may be a neural network model. In some embodiments, positional encoder 130 also is a foundational neural network model that does not require any training. Alternatively, positional encoded 130 may be a set of pre-determined equations instead of a neural network model. The equations compute the positional encoding. Positional encoder 130 receives as input the coordinates for bounding box 128. It converts the coordinates into positional embeddings 132. Positional embeddings 132 may relate to the location of bounding box 128 within image 110. For example, positional embeddings 132 may contain information on the location of bounding box 128 and, therefore, the objects of interest, features, or possible defects.

In addition to text encoder model 112 and visual encoder model 114, model architecture 102 includes image encoder model 116. Image encoder model 116 is a neural network model that receives image 110. In some embodiments, image encoder model 116 is a foundation neural network model, which does not require any training. Image encoder model 116 may receive the entire image 110 as opposed to regions of interest within image 110, as provided to visual encoder model 114. Image encoder model 116 converts image 110 into image embeddings 124. An image embedding 124 allows model architecture 102 to understand visual inputs. It may be a numeric representation of image 110 that encodes the semantics of the contents of the image. In some embodiments, image embedding 124 may be a vector having the data points as the numeric representation.

Image embedding 124 from image encoder model 116 and positional embedding 132 from positional encoder 132 are input into mask decoder model 134. Mask decoder model 134 analyzes the region information of positional embedding 132 and produces a segmentation mask 138 on an area within output 136. Output 136 may be a file. More particularly, output 136 may be an image file similar to image 110 but having segmentation mask 138 on the region defined by text object 108 and free-form text 106. An example of output 136 and segmentation mask 138 is disclosed below.

FIG. 2 depicts a block diagram of cross-modality fusion layer 118 for use with text encoder model 112 and visual encoder model 114 according to the disclosed embodiments. As disclosed above, cross-modality fusion layer 118 may exchange data with text encoder model 112 and visual encoder model 114. FIG. 2 shows an example of the fusion of outputs from layers within the models, that is then used as inputs to subsequent layers in the models.

Text object 108 is received at text encoder model 112. Text object 108 includes data related to free-form text 104. Text object 108 is provided to input layer 202 of text encoder model 112. Input layer 202 includes nodes 204 that receive the input, or text object 108, and performs an operation with regard to the data at the respective node. Nodes 204 then output the results to one or more hidden layers 206 for text encoder model 112. Hidden layers 206 may perform convolutional node processing of data through each layer until the final layer provides inputs to nodes 220 of output layer 218.

Each node within hidden layers 206 receives input from each node in the preceding layer. For example, each node within the first hidden layer will receive output from nodes 204 of input layer 202. The output of each node is provided to each of the nodes in the subsequent layer. This process is repeated for each hidden layer. Thus, nodes 220 of output layer 218 will receive inputs from each node in the last hidden layer of hidden layers 206.

As may be appreciated, any number of nodes may be used in the layers. For example, input layer 202 includes four nodes 204 but may include more. Output layer 218 also may show four nodes 220, but also may include more. The number of input nodes 204 may match the number of output nodes 220. The number of nodes for each hidden layer 206 may be consistent. The number of nodes for hidden layers 206, however, may differ from the number of input nodes 204 and output nodes 220.

The output of output layer 218 is text embeddings 120. Text embeddings 120 include a vector 242 for the data points calculated by output layer 218. The number of data points may correspond to the number of output nodes 220. Vector 242 includes data points having values as determined by text encoder model 112. For example, vector 242 may include data points T1, T2, T3, up to TN.

Visual encoder model 114 may operate in the same manner as text encoder model 112, except that its input is a region 228. Region 228 may be a region of interest identified in image 110. Region 228, which also may be an image, is input to input layer 230. Input layer 230 may include nodes much like input layer 202 of text encoder model 112, but are not shown. The output of input layer 202 is provided to hidden layers 232, which operates much like hidden layers 206 of text encoder model 112. The last hidden layer of hidden layers 232 provides the input to output layer 234. Output layer 234 also includes output nodes much like output layer 218 of text encoder model 112, but are not shown.

The output of visual encoder model 114 is region embeddings 122. Region embeddings 122 includes a vector 244 for data points calculated by output layer 234. The number of data points may correspond to the number of output nodes for output layer 234. Vector 244 includes data points having values are determined by visual encoder model 114. For example, vector 244 may include data points R1, R2, R3, up to RN. According to embodiments, cross-modality decoder model 126 will analyze the data points in vector 242 and vector 244 to determine how close the data points are to each other. Based on the distance between data points T1, T2, T3, to TN and data points R1, R2, R3, to RN, a confidence score may be determined for a bounding box 128.

In addition to the processing operations disclosed above, cross-modality fusion layer 118 is implemented to fuse outputs of hidden layers 206 and hidden layers 232 for subsequent use within text encoder model 112 and visual encoder model 114. The output of each hidden layer 206 for text encoder model 112 is fused with the output of the corresponding hidden layer 232 for visual encoder model 114.

For example, a first hidden layer 210 may receive input 208 from the preceding hidden layer. Each node within first hidden layer 210 receives all the outputs from the nodes in the preceding layer. Inputs 208 are only shown for the bottom-most node for brevity. The nodes of first hidden layer 210 process inputs 208 to generate outputs 212. Each output 212 of the nodes is provided as input to each node of second hidden layer 214.

In addition, outputs 212 for each node of first hidden layer 210 are provided to cross-modality fusion layer 118. Output 212 are shown within cross-modality fusion layer 118 having values TO1, TO2, TO3, up to TON. The number of values TO may correspond to the number of nodes within first hidden layer 210. The process disclosed above also is executed in hidden layers 232 of visual encoder model 232. The process is not shown within hidden layers 232 for brevity. A first hidden layer of hidden layers 232 includes nodes that generate outputs 226 that are provided to cross-modality fusion layer 118. Outputs 226 includes values RO1, RO2, RO3, up to RON. In some embodiments, the number of values for outputs 226 matches the number of values for outputs 212.

Cross-modality fusion layer 118 takes the values for outputs 212 and 226 and fuses them to generate fused values 224. For example, value TO1 is fused with value RO1 to generate fused value FO1. To fuse the values, the disclosed embodiments may pass the embeddings into another neural network that performs a series of nonlinear operations to computed the fused features. For example, value TO2 is fused with value RO2 to generate fused value FO2. Value TO3 is fused with value RO3 to generate fused value FO3. This process continues to value TON being fused with value RON to generate fused value FON. Fused values 224 then are used as inputs 212 to the nodes of second hidden layer 214 of hidden layers 206 for text encoder model 112. The same relationship may be implemented for a subsequent layer within hidden layers 232 of visual encoder model 114.

The disclosed fusion process may occur between each layer with hidden layers 206 and 232. Alternatively, the fusion process using cross-modality fusion layer 118 may occur within a subset of hidden layers with models 112 and 114. The disclosed fusion process allows for the learning of a more performant model.

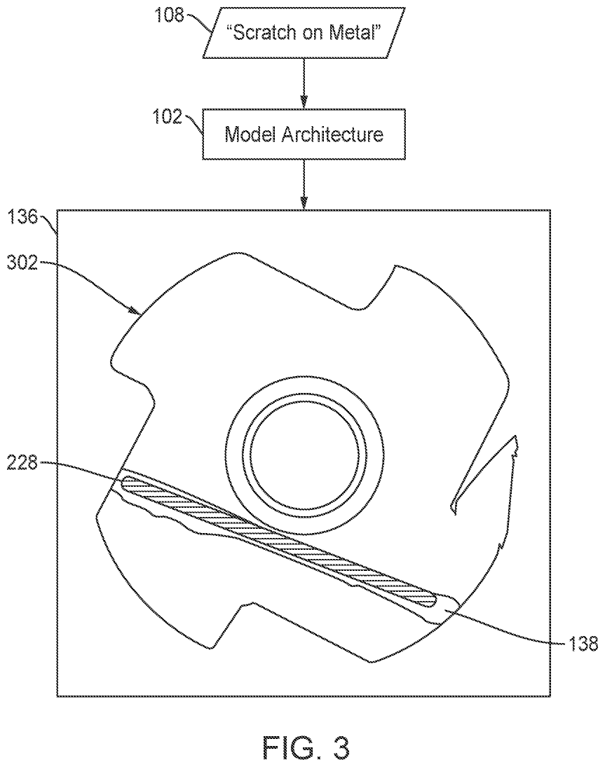

FIG. 3 depicts an example output 136 having a segmentation mask 138 using model architecture 102 according to the disclosed embodiments. The input image, or image 110, may be of a component 302. Component 302 may be a metallic part for an aircraft. Free-form text 106 within text prompt 104 is provided. For example, free-form text 106 may be “Scratch on Metal.” This text is placed into text object 108 and provided to text encoder model 112 of model architecture 102.

Region 228 also may be defined within image 110 of component 302. Region 228 may be defined as a region of interest. Alternatively, image 110 of component 302 may be broken down into different regions based on some parameters. Region 228 is inputted into visual encoder model 114. Image 110 of component 302 is input into image encoder model 116. Model architecture 102 executes the processes disclosed herein to generate output 136. As disclosed above, segmentation mask 138 is generated that highlights region 228 within the image for output 136. Segmentation mask 138 also reflects free-form text 106 of text object 108. Thus, the disclosed embodiments provide a way to define the scratch on metal for component 302 using natural language and models that do not require training images showing the scratch, component, or region of interest.

It may be appreciated that output 136 may include multiple segmentation masks 138. For example, multiple scratches on metal may be found on component 302. Segmentation mask 138 also may be defined within output 136 based on the status of the pixels within the output image. If a pixel is within a segmentation mask 138 as defined by mask decoder model 134, then it may have a value of 1, or in the mask. If the pixel is not within the mask, then it may have a value of 0. When generating output 136, pixels having a value of 1 may be “masked” or have a specified pixel value to change the color or appearance within output 136. If the value is 0, then the pixel may stay its original value.

Output 136 also may be used for post-processing after being generated by model architecture 102. It may be inspected to review the region defined by a segmentation mask 138. Additional operations may determine the size of the defect using the mask. Human inspection may be performed to inspect the alleged defect or feature defined by free-form text 106. Output 136 may go through additional post-processing operations, such as being analyzed by additional neural network models to determine if the identified feature is a defect. The output segmentation mask 138 covers the area of the identified defect. Thus, if there is a mask produced according to the disclosed embodiments, then they believe that portion covered by the mask is an instance of the defect described in the text prompt. Other post-processing may be executed to compute the size of the defect based on segmentation mask 138.

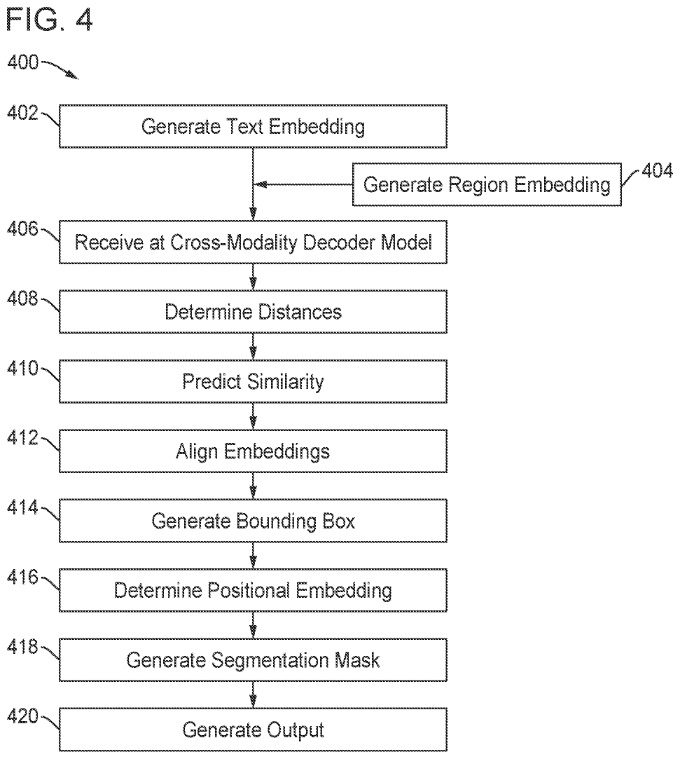

FIG. 4 depicts a flowchart 400 for industrial defect identification using inspection system 100 according to the disclosed embodiments. Flowchart 400 may refer to FIGS. 1-3 for illustrative purposes. Flowchart 400, however, is not limited to the embodiments disclosed by FIGS. 1-3.

Step 402 executes by generating text embedding 126 based on free-form text 106 in text object 108. Text embedding 126 is generated by text encoder model 112. Step 404 executes by generating region embedding 122 based on a region 228 of interest within image 110. Region embedding 122 is generated by visual encoder model 114. During the execution of steps 402 and 404, cross-modality fusion layer 118 may be used to fused outputs from hidden layers within the models to be used as inputs into a subsequent hidden layer. The fused values are distributed back to the models so that features of text object 108 may be used to define region embedding 122 and features of region 228 may be used to define text embedding 120.

Step 406 executes by receiving text embedding 120 and region embedding 122 at cross-modality decoder model 126. Step 408 executes by determining distances between the data points within text embedding 120 and region embedding 122. The embeddings may include vectors that define points in space. The distance between these points are determined. Step 410 executes by predicting a similarity between text embedding 120 and region embedding 122 based on the distances determined above. Cross-modality decoder model 126 predicts the similarity between the text and the region provided to model architecture 102. The predicted similarity may be used to determine a confidence score for the similarity between the text object and region.

Step 412 executes by aligning text embedding 120 with region embedding 122 based on coordinates for the data points within the embeddings. Step 414 executes by generating a bounding box 128 for the aligned data points for the embeddings. Bounding box 128 include coordinates within space. Step 416 executes by determining positional embedding 132 using the coordinates for bounding box 128. Positional embedding 132 indicates a location of the text object within the region of image 110, if similar.

Step 418 executes by generating a segmentation mask 138 using mask decoder model 134. Mask decoder model 134 inputs positional embedding 132 along with image embedding 124 generated by image encoder model 116. Step 420 executes by generating output 136 having segmentation mask 138. Output 136 identifies the defect or feature corresponding to free-form text 106 provided above within image 110. The identified defect or feature may be used by inspection system 100 for further post-processing.

The above steps occur without training any of the models used by model architecture 102. Thus, not all possible defects or features need to be defined and used for training models to identify instances of the defects or features in images. Further, the disclosed embodiments may use natural language to utilize inspection system 100 as opposed to codes, defined terms, or training a model to recognize these terms.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, the present invention may take the form of a computer program product embodied in any tangible medium of expression having computer-usable program code embodied in the medium.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

1. A method comprising:
generating a text embedding using a text encoder model for a text object of free-form text;
generating a region embedding within an image using a visual encoder model, wherein the region embedding defines a region of interest within the image;
fusing output of a layer within the text encoder model with output of a layer within the visual encoder model using a cross-modality fusion layer;
using the fused outputs of the layers of the text encoder model and the visual encoder model as input to a subsequent layer of the text encoder model and the visual encoder model;
aligning the text embedding with the region embedding to generate a bounding box for at least one instance of the text object using a cross-modality decoder model if the at least one instance of the text object is present in the image; and
generating a positional embedding using a positional encoder based on coordinates of the bounding box, wherein the positional embedding indicates a location of the at least one instance of the text object within the image.

2. The method of claim 1, further comprising
providing the image to an image encoder model; and
generating an image embedding for the image.

3. The method of claim 2, further comprising receiving the positional embedding from the positional encoder and the image embedding from the image encoder model at a mask decoder.

4. The method of claim 3, further comprising generating a segmentation mask for the at least one instance of the text object within the image using the mask decoder.

5. The method of claim 4, wherein the segmentation mask covers an area of a defect to be identified within the image for a component under inspection.

6. The method of claim 1, further comprising creating a bounding box for the region of interest of the region embedding.

7. The method of claim 6, further comprising determining a confidence score for the bounding box.

8. The method of claim 7, wherein the confidence score is based a similarity between the text embedding and the region embedding.

9. The method of claim 1, wherein the text embedding is a vector generated by the text encoder model.

10. The method of claim 1, wherein the region embedding is a vector generated by the visual encoder model.

11. The method of claim 1, wherein the text encoder model is trained using a curated natural language dataset.

12. A method for industrial defect identification, the method comprising:
receiving an image of a component;
receiving a text object of free-form text describing a defect of the component to be identified within the image;
generating a text embedding using a text encoder model based on the text object;
generating a region embedding for the image using a visual encoder model,
wherein the region embedding defines a region of interest within the image, and
wherein the outputs of at least one layer within the visual encoder model are fused with outputs of at least one layer within the text encoder model so that the fused outputs are input into a subsequent layer within the text encoder model and the visual encoder model;
predicting how similar the text embedding and the region embedding are to each other using a cross-modality decoder model;
determining a positional embedding using a positional encoder based on the prediction, wherein the positional embedding indicates a location of an instance of the text object within the image; and
generating a segmentation mask for the instance of the text object based on the positional embedding.

13. The method of claim 12, further comprising
providing the image to an image encoder model; and
generating an image embedding for the image.

14. The method of claim 13, further comprising receiving the positional embedding from the positional encoder and the image embedding from the image encoder model at a mask decoder.

15. The method of claim 14, further comprising generating the segmentation mask for the instance of the text object within the image using the mask decoder.

16. The method of claim 12, further comprising
creating a bounding box for the instance of the text object if the instance of the text object is present in the image; and
determining a confidence score for the bounding box.

17. A system for industrial defect identification, the system comprising:
a text encoder model configured to generate a text embedding for a text object of free-form text, wherein the text object relates to a feature within an image of a component;
a visual encoder model configured to generate a region embedding within the image of the component, wherein the region embedding defines a region of interest within the image;
a cross-modality fusion layer configured to fuse output of a layer within the text encoder model with output of a layer within the visual encoder model, wherein the fused outputs of the layers of the text encoder model and the visual encoder model are used as inputs to a subsequent layer of the text encoder model and the visual encoder model;
a cross-modality decoder model configured to align the text embedding with the region embedding to generate a bounding box for at least one instance of the text object if the at least one instance of the text object is present in the image; and
a positional encoder configured to generate a positional embedding based on coordinates of the bounding box, wherein the positional embedding indicates a location of the text object within the image.

18. The system of claim 17, further comprising an image encoder model configured to generate an image embedding for the image.

19. The system of claim 18, further comprising a mask decoder configured to receive the positional embedding from the positional encoder and the image embedding from the image encoder model.

20. The system of claim 19, wherein the mask decoder is further configured to generate a segmentation mask for the at least one instance of the text object within the image.
